(19) United States
(12) Patent Application Publication
(10) Pub. No.: US 2007/0178003 A1
(43) Pub. Date: Aug. 2, 2007

(54) GEAR PUMP WITH RIPPLE CHAMBER FOR LOW NOISE AND PRESSURE RIPPLES

(75) Inventors: Jonathan Zhu, Portage, MI (US); John Jones, Kalamazoo, MI (US); Joseph Kovach, Aurora, OH (US); Chris Johnson, Salem, OH (US)

Correspondence Address: DON W. BULSON (PARKER HANNIFIN);RENNER, OTTO, BOISSELLE & SKLAR, LLP, 1621 EUCLID AVENUE / 19TH FLOOR, CLEVELAND, OH, 44115, US

(73) Assignee: PARKER-HANNIFIN CORPORATION, Cleveland, OH (US)

(21) Appl. No.: 11/562,814

(22) Filed: Nov. 22, 2006

Related U.S. Application Data
(60) Provisional application No. 60/739,050, filed on Nov. 22, 2005.

(51) Int. Cl. F01C 1/18; F01C 1/24; F03C 2/00

(52) U.S. Cl. 418/206.1; 418/206.5

(57) ABSTRACT

A gear pump comprising a gear chamber having opposite side walls; a pair of gears disposed within the gear chamber with teeth thereof meshed with one another, the meshed teeth forming a trap region in which fluid becomes entrapped during rotation of the gears; inlet and outlet chambers on opposite sides of the meshed teeth of the gears and separated from one another by the meshed teeth of the gears; a ripple chamber; and a first passage connecting the ripple chamber to the trap region, whereby the trapped high pressure fluid will flow from the trap region to the ripple chamber to dampen the otherwise generated high pressure pulse.

### RELATED APPLICATIONS

This application claims the benefit of U.S. Provisional Application No. 60/739,050 filed Nov. 22, 2005, which is hereby incorporated herein by reference.

### FIELD OF THE INVENTION

The present invention relates to gear pumps and more particularly to gear pumps having low noise and pump ripples.

### BACKGROUND OF THE INVENTION

Gear pumps generally comprise a gear chamber defined between a pair of side plates. A pair of meshed gears are accommodated in the gear chamber and supported on shafts for rotation. One shaft is rotatably driven to rotate one gear, which in turn rotates the other gear through interaction of the meshed gear teeth. A fluid inlet chamber and a fluid outlet chamber are provided on opposite sides of the meshed teeth of the gears, such that upon rotation of the gears, fluid is sucked from the inlet chamber and discharged at a higher pressure through the outlet chamber.

During rotation of the gears, the nature of the teeth can cause fluid to be trapped in a region defined between the gears and compressed. When hydraulic fluid or other relatively incompressible fluids are being pumped, the pressure of the trapped fluid can be quite high. When the high pressure trapped fluid is released to outlet chamber, a high pressure pulse, or ripple, is produced in the pump output, and this can cause vibration and/or noise.

One approach to this problem is to form relief channels in the side plates adjacent the meshing teeth of the gears for releasing the oil trapped between the teeth. The relief channels have included a high pressure side relief channel extending from the vicinity of the meshing teeth gear to the outlet chamber and a low pressure side relief channel extending from the meshing teeth to the inlet chamber.

### SUMMARY OF THE INVENTION

The present invention provides a gear pump wherein a ripple chamber is provided to dampen pressure pulses arising from fluid trapped between meshed gears of the pump before return of the high pressure trapped fluid to the system. The ripple chamber is of a considerable volume to effect such damping of the pulses.

Accordingly, the invention provides a gear pump comprising a gear chamber having opposite side walls; a pair of gears disposed within the gear chamber with teeth thereof meshed with one another, the meshed teeth forming a trap region in which fluid becomes entrapped during rotation of the gears; inlet and outlet chambers on opposite sides of the meshed teeth of the gears and separated from one another by the meshed teeth of the gears; a ripple chamber; and a first passage connecting the ripple chamber to the trap region, whereby the trapped high pressure fluid will flow from the trap region to the ripple chamber to dampen the otherwise generated high pressure pulse.

The first passage opens to a side wall of the chamber at the trap region. Preferably a second passage extends from the ripple chamber and opens to the chamber at a location just downstream of the trap region in the direction of rotation of the gears, whereby fluid from the ripple chamber will be discharged to the inlet side of the meshed gear teeth after the pressure pulse has been dampened by the ripple chamber.

The ripple chamber preferably has a volume no less than the largest volume of the trap region, and the ripple chamber may be provided in an end plate forming one of the side walls of the gear chamber, with the first passage extending through such wall from the ripple chamber to the gear chamber.

Further features of the invention will become apparent from the following detailed description when considered in conjunction with the drawings.

### BRIEF DESCRIPTION OF DRAWINGS

In the annexed drawings:

FIG. 1 is a sectional view of an exemplary gear pump according to the present invention;

FIG. 2 is a sectional view taken along a line 2-2 of FIG. 1;

FIG. 3-5 are enlarged views showing the meshed gear teeth of the gear pump in relatively rotated positions.

### DETAILED DESCRIPTION

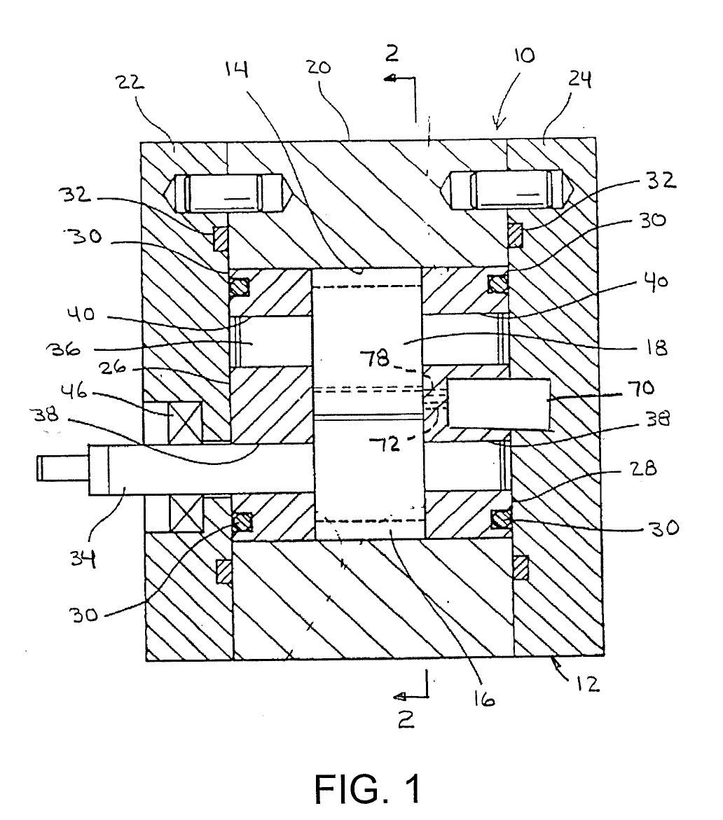

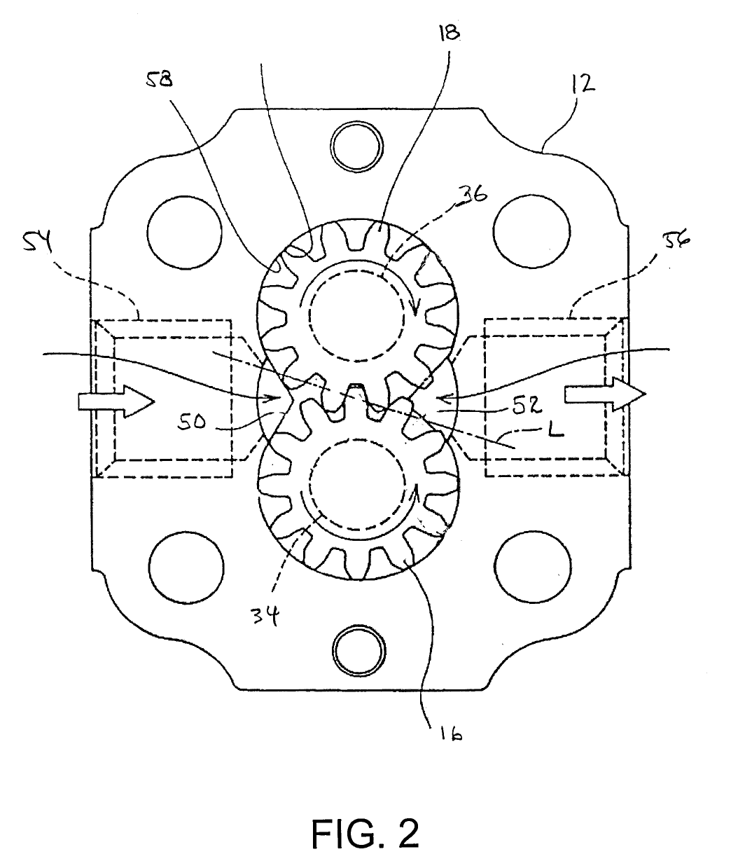

Referring now to the drawings in detail and initially to FIGS. 1 and 2, an exemplary gear pump according to the present invention is designated generally by reference numeral 1. The gear pump 10 has a housing 12 (also sometimes referred to as a casing) including an interior gear chamber 14 containing a pair of gears 16 and 18. In the illustrated embodiment, the housing includes a central body 20 in which the chamber 14 is formed and opposite end plates 22 and 24. The ends of the chamber 14 containing the gears 16 and 18 are closed by thrust plates 26 and 28 located inwardly of the end plates 22 and 24. As is typical of some conventional gear pumps, the thrust plates may be formed by the housing end plates, and still other configurations may be used as may be desired. As shown, seals 30 may be provided between the thrust plates and the corresponding cover plates. In addition, seals 32 may be provided between the end plates and the gear chamber body as shown.

A pair of gear support shafts 34 and 36 are supported at their ends in bores 38 and 40 in the thrust plates. The support shafts are parallel to each other along axes of semicircular opposite side portions of the gear chamber that has a generally elliptical cross section. The support shaft 34 extends through the end plate 26 to outside of the housing 12, serving as a driving shaft for rotating the gear 16 mounted thereto for common rotation. An oil seal 46 may be provided around the support shaft in the end plate. The other support shaft 36 rotatably supports the other gear 18 which is in mesh with the driven gear 16 and thereby will be rotated by the driven gear when the driven gear is rotated.

In FIG. 2, the direction of the rotation of the driving gear and the direction of the rotation of the driven gear are indicated by arrows. As further shown in FIG. 2, an inlet chamber 50 and an outlet chamber 52 are provided on opposite sides of the meshed teeth of the gears, the inlet and outlet chambers respectively being on forward and rearward sides of the meshed teeth with respect to the rotation directions. The inlet chamber and the outlet chamber are respectively connected to inlet and outlet ports 54 and 56 provided for convenient connection to inlet and outlet lines.

With this arrangement, fluid introduced into the inlet chamber 50 via the inlet port 54 is received between teeth of the gears 16 and 18 facing the inlet chamber, and confined in inter-teeth spaces defined by the teeth of the gears and the interior surface 58 of the central body thereby to be delivered into the outlet chamber. The teeth of the driving gear and the driven gear involved in the delivery of the fluid to the outlet chamber 52 are moved through the meshed region of the gears and then once again face the inlet chamber, whereby the fluid is received between the teeth of the gears again for the delivery of the fluid to the outlet chamber 52.

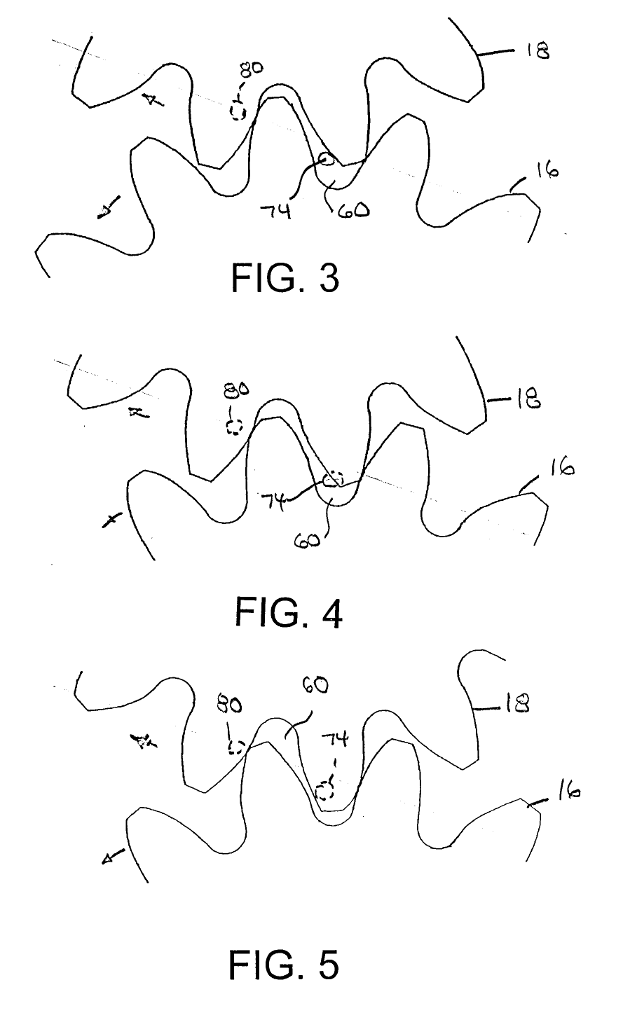

During the operation thus performed by the gear pump, there is a pressure distribution which ranges from a low pressure in the inlet chamber 50 to a high pressure in the outlet chamber 52 with a pressure increase occurring in the gear chamber by the rotation of the gears. During such operation, fluid may be trapped between gear teeth as such teeth move through the meshed region of the gears. This entrapment can best be seen in FIGS. 3-5 where the inter-tooth entrapment region, or simply trap region, is indicated by reference numeral 60. The trap region 60 will decrease in volume causing the trapped fluid to increase in pressure. The pressure increase can be quite high in the case of essentially incompressible fluids such as hydraulic fluid. As will be appreciated, the trap region will translate through the messed region of the gears and ultimately communicate with the outlet chamber, then discharging the high pressure fluid into the outlet chamber and creating a pressure pulse or ripple. As already realized by those skilled in the art, the number of pressure pulses per revolution of the gears will be equal the number of teeth of the gears.

Above mentioned, relief channels (not shown) may be provided in the side faces of the thrust plates that are juxtaposed with respective side faces of the gears. This is done to prevent this so-called trapping phenomenon, i.e., by preventing the operating fluid from being trapped by allowing escape of the fluid to the inlet and/or outlet chambers. Although this assists in operation of the pump, the pump output will still be plagued by noise and/or vibration producing pulses.

In addition, for noise reduction purposes, an attempt has been made to form these grooves in such a manner that high pressure fluid is channeled to the inlet side of the meshed teeth. Such arrangement still will result in significant pressure pulses. The problem is that the fluid pulsation is still introduced back to the system.

The present invention reduces the pressure pulses to a significantly greater extent then prior attempts. This is done by providing a ripple chamber 70 (or chambers) and communicating the ripple chamber via a passage 72 to the trap region 60 between the meshed gear teeth. The ripple chamber has a volume considerably greater than the volume of the trap region. The ripple chamber is connected to the trap region by the passage 72 formed in one of the thrust plates, such as thrust plate 28, and the passage 72 opens to the pump chamber at an opening 74 (FIGS. 3-5). The ripple chamber may be formed in the thrust plate or elsewhere, even including outside the housing if desired. As will be appreciated, the large volume of the ripple chamber will dampen the high pressure pulse before fluid is returned from the ripple chamber to the system. This consequently will reduce the high pressure pulse or ripple as it enters the outlet chamber.

In a preferred embodiment, the ripple chamber 70 is also connected by another passage 78 to the inlet side of the meshed teeth whereby fluid from the chamber will be discharged to the inlet side to reduce the severity of the sudden pressure drop on the inlet side, thereby further contributing to noise and vibration reduction. As shown, the passage may be provided in the thrust plate 28 and opens to the meshed region of the gear teeth at an opening 80 just downstream (in the direction of gear rotation) of the point at which the inter-tooth entrapment region opens to the inlet side of the gears. In FIGS. 2-5, a reference character L denotes an action line of the meshing gears.

The ripple chamber 70 preferably has a volume at least equal the largest trapped volume in the trap region 60, more preferably at least twice as large, still more preferably at least five times as large and yet more preferably at least ten times as large. Consequently, the openings 74 and 80 will have a cross-sectional area considerably less than the cross-sectional area of the ripple chamber, and thus function as an orifice.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A gear pump comprising a gear chamber having opposite side walls; a pair of gears disposed within the gear chamber with teeth thereof meshed with one another, the meshed teeth forming a trap region in which fluid becomes entrapped during rotation of the gears; inlet and outlet chambers on opposite sides of the meshed teeth of the gears and separated from one another by the meshed teeth of the gears; a ripple chamber; and a first passage connecting the ripple chamber to the trap region, whereby the trapped high pressure fluid will flow from the trap region to the ripple chamber to dampen the otherwise generated high pressure pulse.

2. A gear pump as set forth in claim 1, wherein the first passage opens to a side wall of the chamber at the trap region.

3. A gear pump as set forth in claim 2, including a second passage extending from the ripple chamber and opening to the chamber at a location just downstream of the trap region in the direction of rotation of the gears, whereby fluid from the ripple chamber will be discharged to the inlet side of the meshed gear teeth after the pressure pulse has been dampened by the ripple chamber.

4. A gear pump as set forth in claim 1, wherein the ripple chamber has a volume no less than the largest volume of the trap region.

5. A gear pump as set forth in claim 1, wherein the ripple chamber is provided in an end plate forming one of the side walls of the gear chamber, and the first passage extends through such wall from the ripple chamber to the gear chamber.
